(19) United States
(12) Patent Application Publication
(10) Pub. No.: US 2007/0229373 A1
(43) Pub. Date: Oct. 4, 2007

(54) Folding Portable Wireless Apparatus

(75) Inventors: Nobuharu Mashima, Toyama (JP); Masayoshi Hirai, Kanagawa (JP); Kiyoshi Nakanishi, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO. LTD., Kadoma-shi, Osaka (JP)

(21) Appl. No.: 11/568,983

(22) PCT Filed: May 17, 2005
(86) PCT No.: PCT/JP05/08985

§ 371 Date: Nov. 13, 2006

(30) Foreign Application Priority Data
May 18, 2004 (JP) 2004-147530

(51) Int. Cl. H01Q 1/24

(52) U.S. Cl. 343/702

(57) ABSTRACT

In a folding-type portable wireless equipment having the structure that a bendable plane-shaped coupling member is used for a opening and closing mechanism of cases, to realize the antenna configuration which can improve antenna performance and maintain high communication quality.

In the configuration which includes a first case 11 having a first circuit board 101 and a second case 12 having a second circuit board 102 and in which the first case 11 and the second case 12 are coupled by a coupling portion 13 constituting a bendable plane-shaped coupling member, a coupling element 103 for coupling the first circuit board 101 and the second circuit board 102, an antenna element 104, and a feeder line 105 for coupling the antenna element 104 and a wireless circuit portion 106 are disposed at a position almost along the coupling portion 13 so as not to overlap with the first circuit board 101 and the second circuit board 102, whereby the antenna element 104 is disposed between the two circuit boards in the opened state of the cases and disposed outside of the end portions of the two circuit boards in the closed state.

### TECHNICAL FIELD

The present invention relates a folding-type portable wireless equipment having an antenna for radio communication, in which two cases are coupled to each other via a bendable plane-shaped coupling member so as to be opened and closed.

### BACKGROUND ART

In portable telephones etc., folding-type portable wireless equipments have been widely used in each of which two cases are coupled to each other via a hinge portion etc. so as to be opened and closed. In such a kind of folding-type portable wireless equipment, a hinge mechanism in which a coupling portion of the cases rotates is used generally. There is proposed an electronic device having the structure that the holding of the opened and closed states of cases are realized by using a bendable plane-shaped coupling member in placed of such a hinge mechanism (see JP-A-5-259656, for example). This conventional example is configured in a manner that a hinge portion is formed by soft resin which is integrated with cases and the opened state of the cases is kept by utilizing the elasticity of the soft resin.

However, in the configuration of the electronic device like the aforesaid conventional example, there arises a problem that an antenna necessary in the case of applying to a portable wireless equipment can not be provided easily and so antenna performance can not be secured.

### DISCLOSURE OF THE INVENTION

<Problem That the Invention is to Solve>

The invention is made in view of the aforesaid circumstance and an object of the invention is to provide a folding-type portable wireless equipment which can improve antenna performance in a folding-type portable wireless equipment having the structure for opening and closing cases by using a bendable plane-shaped coupling member.

<Means for Solving the Problem>

The folding-type portable wireless equipment according to the invention is arranged in a manner that in the folding-type portable wireless equipment having a first case and a second case, including:

a first circuit board disposed at the first case;

a second circuit board disposed at the second case;

a bendable plane-shaped coupling member which mechanically couples the first case and the second case;

a coupling conductor having flexibility which electrically couples the first circuit board and the second circuit board;

a wireless circuit portion which is provided at the first circuit board or the second circuit board; and

an antenna which is coupled to the wireless circuit portion via a feeder line, wherein

the coupling conductor, the antenna and the feeder line are disposed at positions almost along the plane-shaped coupling member.

Accordingly, in the structure for opening and closing the cases by using the bendable plane-shaped coupling member, the antenna performance can be improved.

As one mode of the invention, in the aforesaid folding-type portable wireless equipment, the plane-shaped coupling member bends so as to be able to open and close between a first state where the first case and the second case are separated and a second state where the first case and the second case are overlapped,

the antenna is disposed at a side portion of the coupling conductor in the plane-shaped coupling member, and

the antenna is provided in a manner that the antenna is disposed at a center portion where the first circuit board and the second circuit board oppose to each other in the first state, and positioned outside of the first circuit board and the second circuit board in the second state.

Accordingly, the antenna performance can be improved in each of the first and second states.

As another mode of the invention, in the aforesaid folding-type portable wireless equipment, each of the first and second cases is configured in a rectangular shape,

the plane-shaped coupling member couples short side portions of the first and second cases to each other, and

the antenna is disposed at a position protruding in a longitudinal direction of the first and second cases in the second state.

Accordingly, the antenna performance in the second state can be improved while maintaining the antenna performance in the first state.

As still another mode of the invention, in the aforesaid folding-type portable wireless equipment, the antenna is provided in a manner that at least apart thereof protrudes outside of the plane-shaped coupling member in the second state.

Accordingly, the antenna performance in the second state can be further improved.

### ADVANTAGES OF THE INVENTION

According to the invention, in the folding-type portable wireless equipment having the structure for opening and closing the cases by using the bendable plane-shaped coupling member, the antenna performance can be improved.

### BRIEF DESCRIPTION OF THE DRAWINGS

FIG. 1 is a perspective view showing the external configuration of a folding-type portable wireless equipment according to the first embodiment of the invention.

FIG. 2 is a front view showing the configuration of a main portion in the opened state of the folding-type portable wireless equipment according to the first embodiment the equipment

FIG. 3 is a side view showing the configuration of the main portion in the closed state of the folding-type portable wireless equipment according to the first embodiment.

FIG. 4 is a perspective view showing the external configuration of a folding-type portable wireless equipment according to the second embodiment of the invention.

FIG. 5 is a side view showing the configuration of a main portion in the opened state of the folding-type portable wireless equipment according to the second embodiment.

<Description of Reference Numerals>

| | |
|---|---|
| 11 | first case |
| 12 | second case |
| 13 | coupling portion |
| 101 | first circuit board |
| 102 | second circuit board |
| 103 | coupling element |
| 104, 109 | antenna element |
| 105, 108 | feeder line |
| 106 | wireless circuit portion |
| 107 | protection cover |

### BEST MODE FOR CARRYING OUT THE INVENTION

In this embodiment, there is shown an example of the configuration of a folding-type portable wireless equipment which is applied to a portable telephone etc.

### First Embodiment

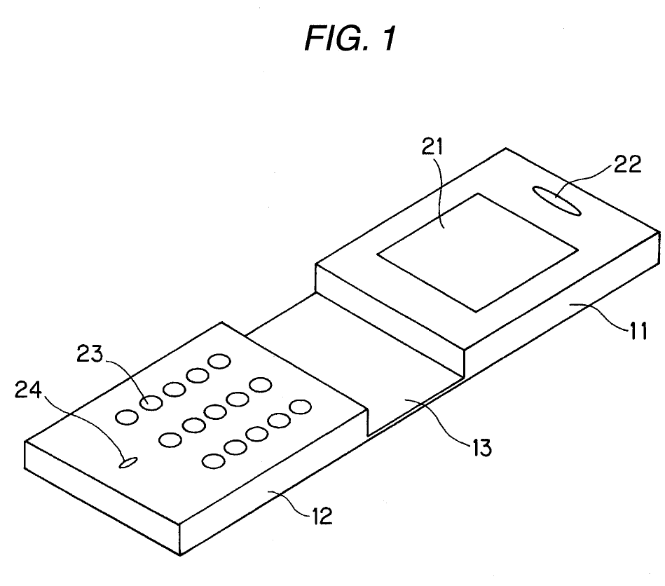

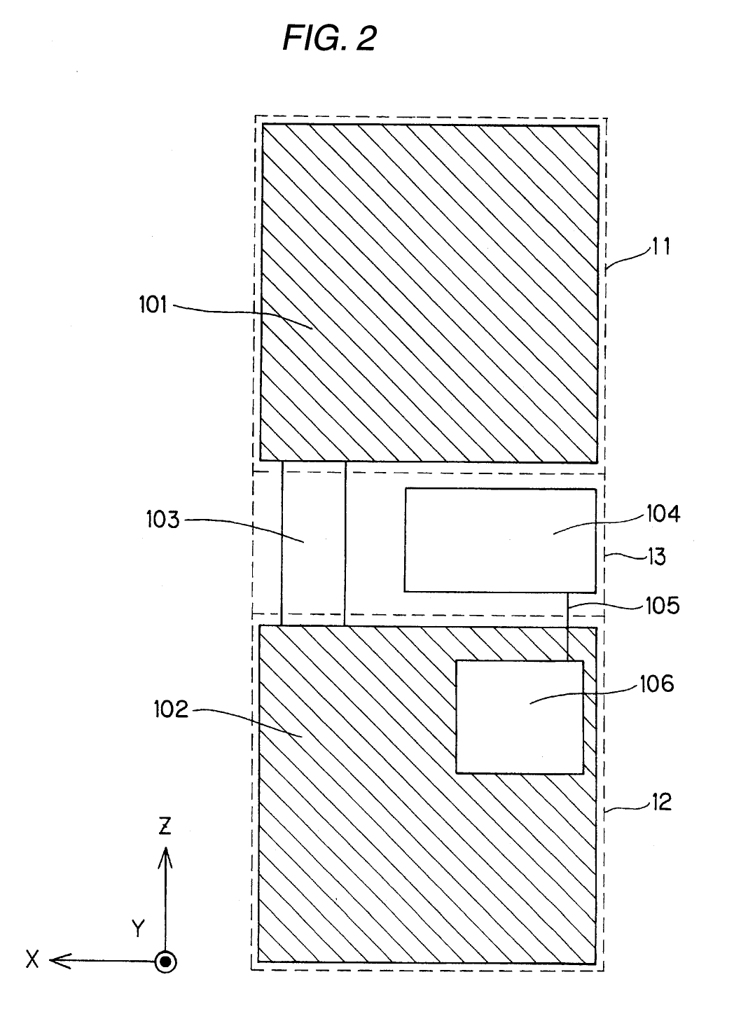

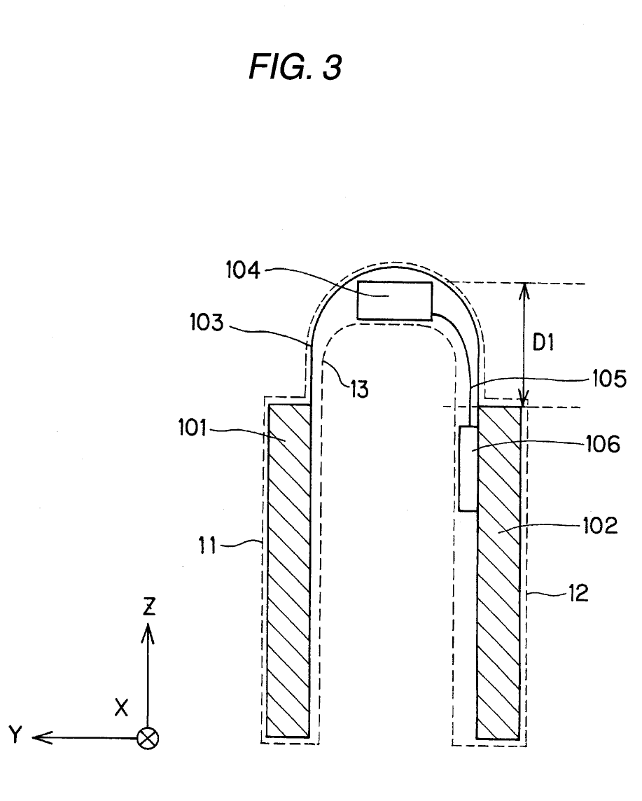

FIG. 1 is a perspective view showing the external configuration of a folding-type portable wireless equipment according to the first embodiment of the invention, FIG. 2 is a front view showing the configuration of a main portion in the opened state of the folding-type portable wireless equipment according to the first embodiment, and FIG. 3 is a side view showing the configuration of the main portion in the closed state of the folding-type portable wireless equipment according to the first embodiment.

As shown in FIG. 1, the folding-type portable wireless equipment according to the embodiment includes a first case 11 and a second case 12 and is configured in a manner that the first case 11 and the second case 12 are coupled to each other via a coupling portion 13 constituting a bendable plane-shaped coupling member so as to be able to open and close these cases. The first case 11 is provided with a display portion 21 constituted by a liquid display device etc. and a receiver 22 etc. The second case 12 is provided with an operating portion 23 having a plurality of operation key buttons and a microphone 24 etc., and includes therein a wireless circuit, a control circuit, an information processing circuit etc.

The coupling portion 13 has an exterior portion which is formed by polymer material etc. with flexibility and includes therein a flexible wiring cable, an antennal element etc. The coupling portion 13 couples the short side portions of the first case 11 and the second case 12 each having a rectangular shape. The first case 11 and the second case 12 are folded so as to be closed and opened by bending the coupling portion 13. Further, although not shown, the coupling portion 13 is provide with a coupling member formed by a metal plate etc. for holding the closed state of the cases, and the exterior portions of the cases are provided with a holding mechanism for holding the opened state.

FIGS. 2 and 3 schematically show the main constituent elements of the embodiment and show the arrangement relation among circuit boards, the antenna element etc. A first circuit board 101 and a second circuit board 102 are housed within the first case 11 and the second case 12, respectively. The first circuit board 101 and the second circuit board 102 are electrically coupled by a coupling element 103 serving as a coupling conductor provided at the portion 103.

The first circuit board 101 is constituted by a printed board with a thickness of 1 mm, for example, and the size of the printed board is set to have a length of 70 mm and a width of 40 mm, for example. A grounding pattern is formed on the first circuit board 101. The second circuit board 102 is constituted by a printed board with a thickness of 1 mm, for example, and the size of this printed board is set to have a length of 70 mm and a width of 40 mm, for example. Like the first circuit board 101, a grounding pattern is formed on the second circuit board 102. This grounding pattern acts as a grounding conductor for the antenna. The coupling element 103 is constituted by a flexible pattern with a thickness of 0.1 mm, for example, and electrically connects between the first circuit board 101 and the second circuit board 102. The size of the coupling element is set to have a length of 40 mm and a width of 5 mm, for example.

In a state (first state) where the cases are opened as shown in FIG. 2, the first circuit board 101, the second circuit board 102 and the coupling element 103 are arranged horizontally on an almost same plane which is almost in parallel to the X-Z plane in FIG. 2, that is, the surface of the cases of the equipment. In this case a distance between the first circuit board 101 and the second circuit board 102 is set to about 45 mm, for example.

The antenna element 104 is constituted by a conductive wire with a diameter of almost 1 mm, for example, and disposed between the first circuit board 101 and the second circuit board 102 at the side portion of the coupling element 103 of the coupling portion 13. The antenna element 104 is constituted by the conductor with a length corresponding to an almost quarter wavelength in the 800 MHz band used in the mobile communication system of the ground cellular system, for example. A wireless circuit portion 106 is provided at the second circuit board 102, and the wireless circuit portion 106 is connected to the antenna element 104 via the feeder line 105.

The coupling element 103, the antenna element 104 and the feeder line 105 are disposed at the positions almost along the portion 103 constituting the plane-shaped coupling member. The antenna element 104 is set to a position which does not overlap with the first circuit board 101, the second circuit board 102 and the coupling element 103 in the state where the cases are opened as shown in FIG. 2. For example, the antenna element is disposed at the center portion which is away by about 6 mm from respective opposing edges of the first circuit board 101 and the second circuit board 102.

In a state (second state) where the cases are closed as shown in FIG. 3, the first circuit board 101 and the second circuit board 102 are disposed so as to be overlapped almost in parallel to each other in a state that the first and second circuit boards are opposed to each other. The antenna element 104 is disposed at the position outside of the boards in the Z direction in FIG. 3, that is, in the extended direction in parallel to the first circuit board 101 and the second circuit board 102.

When the longitudinal direction of the boards is set in the vertical direction, the antenna element 104 is disposed at the high position protruding in the longitudinal direction from the first circuit board 101 and the second circuit board 102. In this case, the distance between the first circuit board 101 and the second circuit board 102 is set to about 15 mm, for example, and the distance D1 between the end portion of the board and the antenna element 104 is set to about 20 mm, for example. Since the antenna element 104 is disposed so as to be spaced in the longitudinal direction (Z direction) of the boards from the second circuit board 102 serving as the grounding conductor for the antenna, the antenna performance can be improved in the closed state of the cases.

In the antenna configuration of the aforesaid embodiment, the antenna element 104 and the second circuit board 102 almost serve almost as a half-wave dipole antenna at 800 MHz. In order to theoretically constitute the half-wave dipole antenna at 800 MHz, the entire length of the antenna element is required to be about 190 mm. The sufficient antenna performance can be secured with the configuration of the aforesaid example of the size in the opened state of the cases shown in FIG. 2.

However, in the closed state of the cases shown in FIG. 3, the aforesaid example of the size intended to miniaturization can secure the element length of only about 120 mm. Thus, for example, if the distance D1 between the end portion of the board and the antenna element 104 or the entire length of the second circuit board 102 can be extended, the effective area of the antenna can be expanded, whereby the antenna performance can be improved.

According to the first embodiment, since the antenna element is disposed between the first and second circuit boards, the antenna can be constituted by the electromagnetic coupling between the antenna element and the first circuit board. Further, in the closed state of the cases, since the antenna is configured in a manner that the antenna element is disposed at the position outside of the boards from the end portions of the first circuit board and the second circuit board in the longitudinal direction of the boards, the antenna performance can be improved in each of the opened and closed states.

The length and the shape of the antenna element 104 are not limited to the aforesaid example of the configuration. For example, the antenna element may be configured in a helical structure and may be incorporated within dielectric material. Further, even in the frequency band other than 800 MHz band used in the mobile communication system of the ground cellular system, the similar effects can be obtained by adjusting the electric length so long as the equipment has the configuration similar to this embodiment.

### Second Embodiment

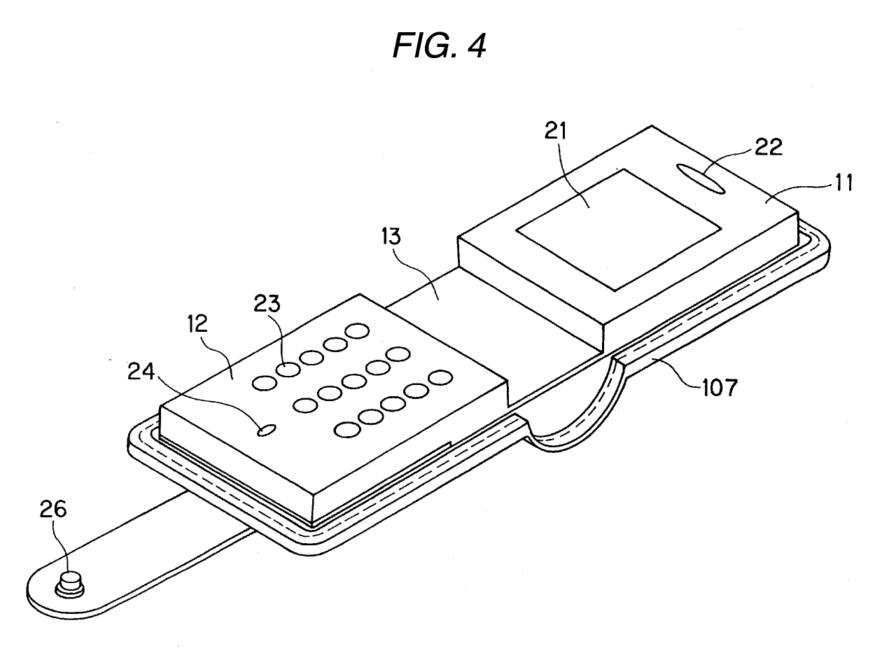

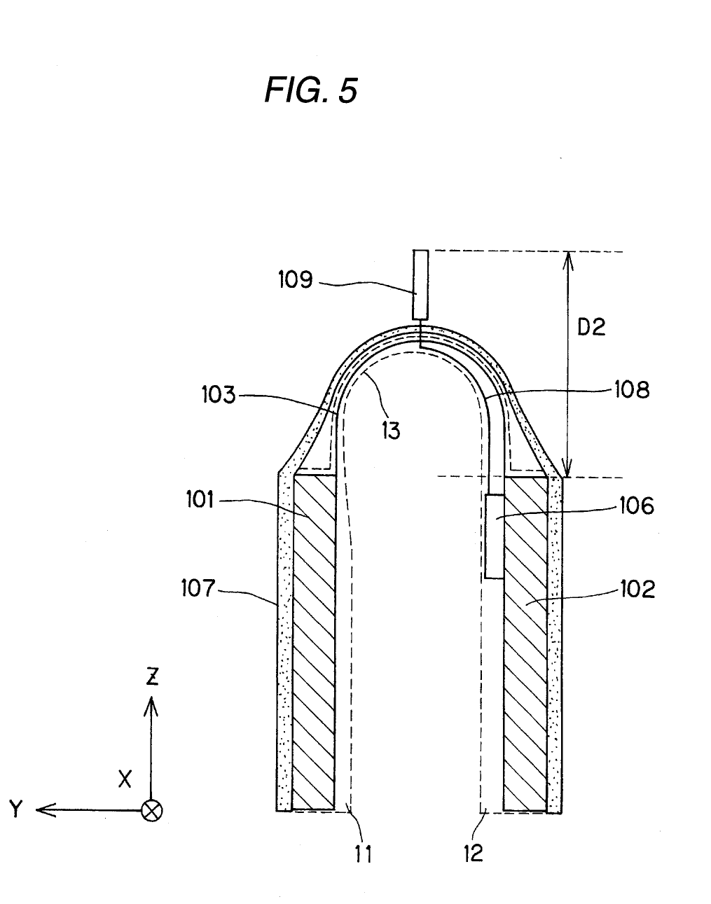

FIG. 4 is a perspective view showing the external configuration of a folding-type portable wireless equipment according to the second embodiment of the invention, and FIG. 5 is a side view showing the configuration of a main portion in the opened state of the folding-type portable wireless equipment according to the second embodiment.

The folding-type portable wireless equipment according to the second embodiment is configured in a manner that a protection cover 107 is provided at a rear surface portion which is an outside surface at the time of opening and closing the first case 11 and the second case 12. Incidentally, constituent elements similar to those of the first embodiment are marked with the same references and therefore need not be described

A protection cover 107 is configured by non-conductive material having elasticity. For example, the protection cover 107 is constituted by a cloth with the thickness of about 1 mm and disposed so as to cover the entirety of the folding-type portable wireless equipment. A fixing member 26 for holding the closed state of the cases is provided protrusively at the one end portion of the protection cover 107 so as to engage with a not-shown fixing member provided at the other end of the protection cover 107.

In the state where the cases are closed as shown in FIG. 5, an antenna element 109 is disposed at the position outside of the boards so as to protrude outside of the coupling portion 13 and the protection cover 107 in the Z direction in FIG. 5, that is, in the extended direction in parallel to the first circuit board 101 and the second circuit board 102. When the longitudinal direction of the boards is set in the vertical direction as shown in FIG. 5, the antenna element 109 is disposed at the tip position of the coupling portion 13. A feeder line 108 is disposed along the coupling portion 13 in a state almost in parallel to the inner wall of the protection cover 107 so as to connect the antenna element 109 with the wireless circuit portion 106 provided at the second circuit board 102. The feeder line 108 is constituted by a flexible pattern with the thickness of 0.1 mm and the width of 1 mm, for example. In this case, the distance D2 between the tip end of the antenna element 109 and the end portion of the second circuit board 102 is set to about 30 mm, for example.

The antenna element 109 is constituted by a flexible pattern with the thickness of 0.1 mm and the width of 1 mm, for example. Further, the antenna element 109 is disposed in a state that the periphery thereof is covered and protected by flexible non-conductive resin material with a thickness of 0.5 mm, for example, whereby the disposed position of the antenna element is always held. In this manner, since the antenna element 109 is disposed so as to protrude in the longitudinal direction (Z direction) of the boards from the flexible protection cover 107 made of non-conductive material, the distance between the circuit boards and the antenna element can be made larger (about 10 mm in the aforesaid example of the size) as compared with the first embodiment. Thus, the effective area of the antenna in the closed sate of the cases can be expanded, whereby the antenna performance can be improved.

According to the antenna configuration of the second embodiment, since the effects similar to the first embodiment is obtained in the opened state of the cases, and the distance between the end portions of the circuit boards and the antenna element can be made larger as compared with the first embodiment thereby to dispose the antenna element at the higher position in the closed state of the cases, whereby the antenna performance can be further improved.

Incidentally, the protection cover 107 is not limited to the aforesaid example of the configuration and may be formed by urethane or resin material, for example. Further, the antenna element 109 may be one having meander, for example. Furthermore, even in the frequency band other than 800 MHz band used in the mobile communication system of the ground cellular system, the similar effects can be obtained by adjusting the electric length so long as the equipment has the configuration similar to this embodiment.

As described above, according to the embodiment, in the folding-type portable wireless equipment having the structure for realizing the opening and closing of the cases by using the bendable plane-shaped coupling member and the holding of the opened and closed states, the antenna performance can be improved in each of the opened and closed states. In particular, in the portable telephone, the antenna performance at the time of communication for a person and the standby state can be expected to be improved and so the communication quality can be improved.

Although the invention has been explained in detail with reference to the particular embodiments, it should be obvious for those skilled in the art that various changes and modifications may be made without departing from the spirit and the scope of the invention.

The present application is based on Japanese Patent application No. 2004-147530 filed on May 18, 2004, the content of which is hereby incorporated by reference into this application.

### INDUSTRIAL APPLICABILITY

The invention has the effects that the antenna performance can be improved in the folding-type portable wireless equipment having the structure that the bendable plane-shaped coupling member is used for the opening and closing mechanism of the cases. The invention is useful for the folding-type portable wireless equipment etc. having the radio communication antenna in which the two cases are coupled to each other by the bendable plane-shaped coupling member so as to be able to open and close.

1. A folding-type portable wireless equipment having a first case and a second case, comprising:
a first circuit board disposed at the first case;
a second circuit board disposed at the second case;
a bendable plane-shaped coupling member which mechanically couples the first case and the second case;
a coupling conductor having flexibility which electrically couples the first circuit board and the second circuit board;
a wireless circuit portion which is provided at the first circuit board or the second circuit board; and
an antenna which is coupled to the wireless circuit portion via a feeder line, wherein
the coupling conductor, the antenna and the feeder line are disposed at positions almost along the plane-shaped coupling member.

2. The folding-type portable wireless equipment according to claim 1, wherein
the plane-shaped coupling member bends so as to be able
to open and close between a first state where the first case and the second case are separated and a second state where the first case and the second case are overlapped,
the antenna is disposed at a side portion of the coupling conductor in the plane-shaped coupling member, and
the antenna is provided in a manner that the antenna is disposed at a center portion where the first circuit board and the second circuit board oppose to each other in the first state, and positioned outside of the first circuit board and the second circuit board in the second state.

3. The folding-type portable wireless equipment according to claim 2, wherein
each of the first and second cases is configured in a rectangular shape,
the plane-shaped coupling member couples short side portions of the first and second cases to each other, and
the antenna is disposed at a position protruding in a longitudinal direction of the first and second cases in the second state.

4. The folding-type portable wireless equipment according to claim 3, wherein
the antenna is provided in a manner that at least a part thereof protrudes outside of the plane-shaped coupling member in the second state.
